(19) United States
(12) Patent Application Publication
(10) Pub. No.: US 2015/0205479 A1
(43) Pub. Date: Jul. 23, 2015

(54) NOISE ELIMINATION IN A GESTURE RECOGNITION SYSTEM

(71) Applicant: Intel Corporation, Santa Clara, CA (US)

(72) Inventors: Yongsheng Zhu, Shanghai (CN); Hongbo Min, Shanghai (CN); Zhiqiang Yu, Shanghai (CN)

(21) Appl. No.: 14/129,600

(22) PCT Filed: Dec. 27, 2012
(86) PCT No.: PCT/US2012/071823

§ 371 Date: Dec. 27, 2013

(30) Foreign Application Priority Data
Jul. 2, 2012 (CN) 201210253353.3

(51) Int. Cl. G06F 3/0488; G06F 3/0484

(52) U.S. Cl. CPC G06F 3/0488; G06F 3/04842

(57) ABSTRACT

Generally this disclosure describes noise elimination in a gesture recognition system. A method may include configuring a preprocessor for a gesture recognition module based, at least in part, on a gesture type, the gesture recognition module related to a gesture; generating a first contact history vector in response to a first touch event, the first touch event based on a first contact with a touch screen; providing the first touch event to the gesture recognition module; and determining whether to provide a second touch event to the gesture recognition module based at least in part on the gesture type.

### FIELD

The following disclosure relates to a gesture recognition system, and, more particularly, to noise elimination in a gesture recognition system.

### BACKGROUND

Touch sensitive displays provide a user interface in many mobile devices, including for example, smartphones and tablet computers. For example, icons may be displayed to a user and the user may select an icon by tapping the icon and/or the user may cause another page of icons to be displayed by flicking or swiping (i.e., placing a finger on the display and moving the finger quickly left or right). User inputs (“gestures”) typically include one or more contacts with the touch sensitive display. Each contact may then be captured and interpreted, resulting in a response. Common gestures include tap, long tap (also known as a press or as a tap and hold), pinch and swipe. Gesture recognition typically includes detecting one or more contact(s), location(s) of the contact(s), duration(s) and/or motion of the contact(s). Gesture recognition relies on proper performance of a gesture by a user. Unexpected results may occur if a user inadvertently or unintentionally contacts a touch sensitive display (“noise”) before and/or during a gesture recognition process. Such unexpected results may result in a degraded user experience by causing an undesired result or preventing a desired result.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example device including an example noise elimination system in accordance with various embodiments of the present disclosure;

FIG. 2A illustrates an example of a noise elimination system in accordance with one embodiment of the present disclosure;

FIG. 2B illustrates an example of a contact history system in accordance with one embodiment of the present disclosure;

FIG. 2C illustrates an example of a preprocessor in accordance with various embodiment of the present disclosure;

FIG. 3 illustrates a state transition diagram for a gesture recognition module in accordance with at least one embodiment of the present disclosure;

FIG. 4 is a flowchart of example operations for gesture recognition in accordance with at least one embodiment of the present disclosure;

FIG. 5 is a flowchart of example operations for noise elimination in accordance with at least one embodiment of the present disclosure;

FIG. 6 is a flowchart of example operations for noise elimination in response to a TouchStart event in accordance with at least one embodiment of the present disclosure; and

FIG. 7 is a flowchart of example operations for noise elimination in response to a TouchMove or Touch End event in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

Generally, this disclosure describes a noise elimination method and system for a gesture recognition system. A user may touch (i.e., contact) a touch sensitive display configured to capture the contact and to generate a touch event based, at least in part, on the captured contact. The touch event may be preprocessed by the noise elimination system based on a gesture type of an associated gesture recognition module. A touch event output based on the preprocessor result may then be provided to the associated gesture recognition module. The gesture recognition system may include one or more gesture recognition modules. Each gesture recognition module is configured to recognize one gesture. The touch event may be processed independently concurrently for each gesture and corresponding gesture recognition module.

The method and system are configured to detect inadvertent and/or unintentional contact(s) with the touch sensitive display (i.e., touch screen) and to avoid unexpected results caused by these noise contacts. In a first example, the noise contact may occur prior to intentional initiation of a gesture recognition process interfering with the subsequent gesture recognition process. In this first example, a user may contact a corner of the touch screen unintentionally, for example while holding a device that includes the touch screen. This contact may prevent subsequent gestures from being recognized resulting in no response or an incorrect response. In a second example, the noise contact may occur during a gesture recognition process. In this second example, while performing a gesture, a user may inadvertently contact the touch screen with one or more other fingers. Such inadvertent contact may result in aborting a current gesture recognition process or may result in an erroneous gesture state. A noise elimination system and method consistent with the present disclosure are configured to reduce the likelihood that a user's inadvertent contact(s) will interfere with the gesture recognition process. “Gesture recognition process” as used herein means interpreting touch event(s) to determine a corresponding gesture based on characteristics of one or more contact(s) with a touch screen.

A method and system consistent with the present disclosure are configured to categorize each gesture associated with a respective gesture recognition module according to gesture type based on gesture characteristics (i.e., characteristics of contact(s) associated with a gesture). Gesture characteristics include duration of the contact and/or a distance between an initial position and a most recent position of a contact. For example, Gesture Type One corresponds to a contact with a relatively short duration that does not move, e.g., a tap. A Gesture Type Two corresponds to a contact with a relatively longer duration that does not move, e.g., a long tap. A Gesture Type Three corresponds to a contact that moves, (i.e., a contact with a non-zero distance travelled from its initial contact position), e.g., a pinch. A system and method consistent with the present disclosure may configure a respective preprocessor for each gesture recognition module according to gesture type.

The method and system are configured to generate and store a contact history (i.e., contact history vector) for each detected contact. The contact history vector may be created in response to a contact starting (TouchStart), updated (e.g., TouchMove or time) while the contact continues and deleted when the contact ends (TouchEnd). Each contact history vector may be created and/or updated based, at least in part, on touch event data and/or time (e.g., at expiration of a time interval). Each touch event may include x, y coordinates corresponding to a location of the contact on the touch screen and a time stamp associated with the contact. The contact history vector is configured to include x, y coordinates of a contact initial location and a time stamp associated with the contact initial location, x, y coordinates of a most recent contact location and a time stamp associated with the most recent location, a duration of the contact, and a total distance moved by the contact from the contact initial location to the most recent contact location. Locations may be represented by x, y coordinates associated with the touch screen.

Touch event(s) associated with each contact may then be provided to the preprocessor prior to being provided to the respective gesture recognition module. Based on the contact history, number of active (i.e., concurrent) contacts and/or gesture type, touch event(s) may be provided to the respective gesture recognition module without modification or may be modified as described herein.

Thus, a method and system consistent with the present disclosure are configured to differentiate valid contacts from noise (unintentional) contacts. The system and method are further configured to avoid blocking gesture recognition when noise contacts are not present and to avoid interrupting a gesture that is ongoing. The system and method are configured to select a valid contact from a plurality of candidate contacts and to provide touch event(s) associated with the valid contact to a gesture recognition module. In some embodiments, a touch event corresponding to a noise contact may be provided to a gesture recognition module. Based at least in part on gesture type and contacts characteristics, a valid contact may be identified, the noise contact may be replaced with the valid contact and touch events associated with the valid contact may then be provided to the gesture recognition module. In some embodiments, a best valid contact may be selected from a plurality of possible valid contacts based, at least in part, on gesture type and associated contact characteristics. In this manner, noise contacts may be prevented from causing an inadvertent or unintentional gesture from being recognized.

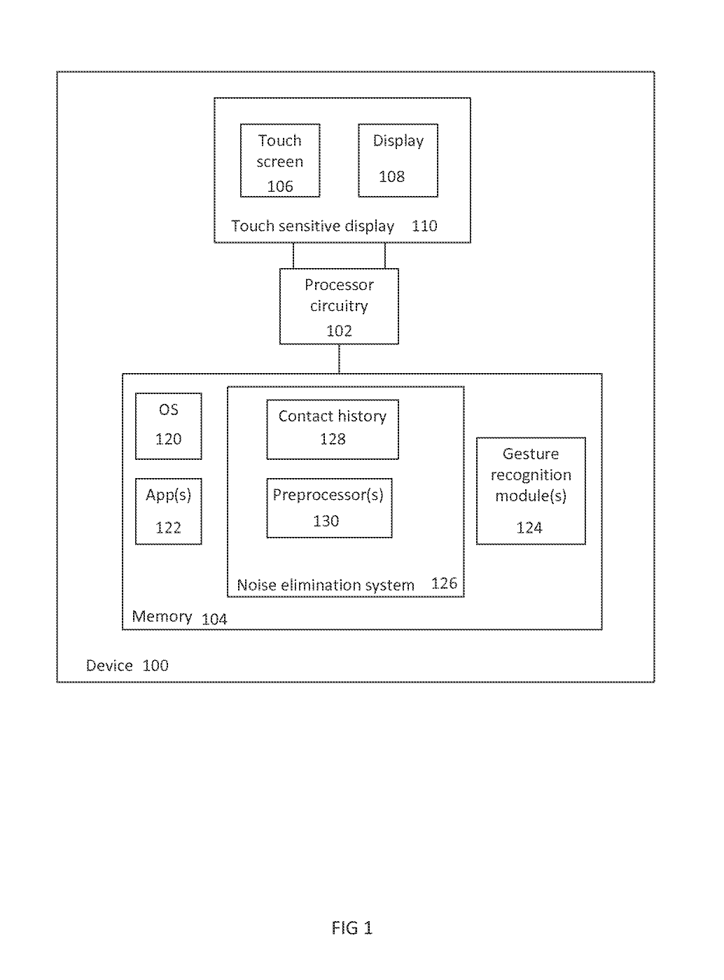

FIG. 1 illustrates a device 100 including an example noise elimination system consistent with various embodiments of the present disclosure. For example, device 100 may include computing devices including, but not limited to desktop computers, laptop computers, tablet computers (e.g., iPad®, GalaxyTab® and the like), ultraportable computers, ultramobile computers, netbook computers, subnotebook computers, mobile telephones, smart phones, (e.g., iPhones®, Android®-based phones, Blackberries®, Symbian®-based phones, Palm®-based phones, etc.), feature phones, personal digital assistants, enterprise digital assistants, mobile internet devices, personal navigation devices, etc.

Device 100 includes processor circuitry 102, memory 104, touch screen 106, and display 108. Memory 104 is configured to store operating system OS 120 (e.g., iOS®, Android®, Blackberry® OS, Symbian®, Palm® OS, etc.), one or more application(s) (“app(s)”) 122, one or more gesture recognition module(s) 124 and noise elimination system 126. Noise elimination system 126 includes contact history 128 and one or more preprocessor(s) 130. In some embodiments, contact history 128 may be included in each preprocessor. Processor circuitry 102 may include one or more processor(s) and is configured to perform operations associated with OS 120, app(s) 122, gesture recognition module(s) 124, contact history 128 and preprocessor(s) 130.

Contact history 128 is configured to store contact history vectors corresponding to contacts. A contact history vector may be initialized in response to a contact starting (e.g., to a TouchStart event). The contact history vector may be updated based on time and/or another touch event (associated with the contact) for the duration of the contact. The contact history vector may then be reset (e.g., deleted) when the contact ends (e.g., TouchEnd event).

Preprocessor(s) 130 are configured to receive touch event(s) from touch screen 106 and gesture state(s) from gesture recognition module(s) 124. Preprocessor(s) 130 are further configured to provide touch event output(s) based, at least in part, on contact history 128, touch event, gesture type and gesture state, as described herein.

Touch screen 106 is configured to capture touches associated with contacts, including but not limited to, tap (e.g., single tap, double tap, long tap (i.e., tap and hold), etc.), pinch and stretch, swipe, etc., and to output touch event(s) based on the captured contact. A touch event may include a contact location, e.g., x, y coordinates, corresponding to a position of the contact on the touch screen. A touch event may further include a time parameter, e.g., time stamp, corresponding to a time that the contact was detected. The time stamp may be provided by OS 120 in response to a contact. Display 108 includes any device configured to display text, still images, moving images (e.g., video), user interfaces, graphics, etc. Touch screen 106 and display 108 may be integrated into a touch-sensitive display 110. Touch-sensitive display 110 may be integrated within device 100 or may interact with the device via wired (e.g., Universal Serial Bus (USB), Ethernet, Firewire, etc.) or wireless (e.g., WiFi, Bluetooth, etc.) communication.

Gesture recognition module(s) 124 are configured to receive touch events and to determine whether contact(s) associated with the received touch events correspond to predefined gesture(s). A gesture may include one or more contacts. A contact may be characterized based on, for example, duration and/or movement. Gesture recognition module(s) 124 may include custom, proprietary, known and/or after-developed gesture recognition code (or instruction sets) that are generally well-defined and operable to determine whether received touch event(s) correspond to predefined gestures. Typically each gesture recognition module is configured to determine (i.e., “recognize”) one gesture. For example, a tap gesture module is configured to recognize a tap gesture, a pinch gesture module is configured to recognize a pinch gesture, a long tap gesture module is configured to recognize a long tap gesture, etc.

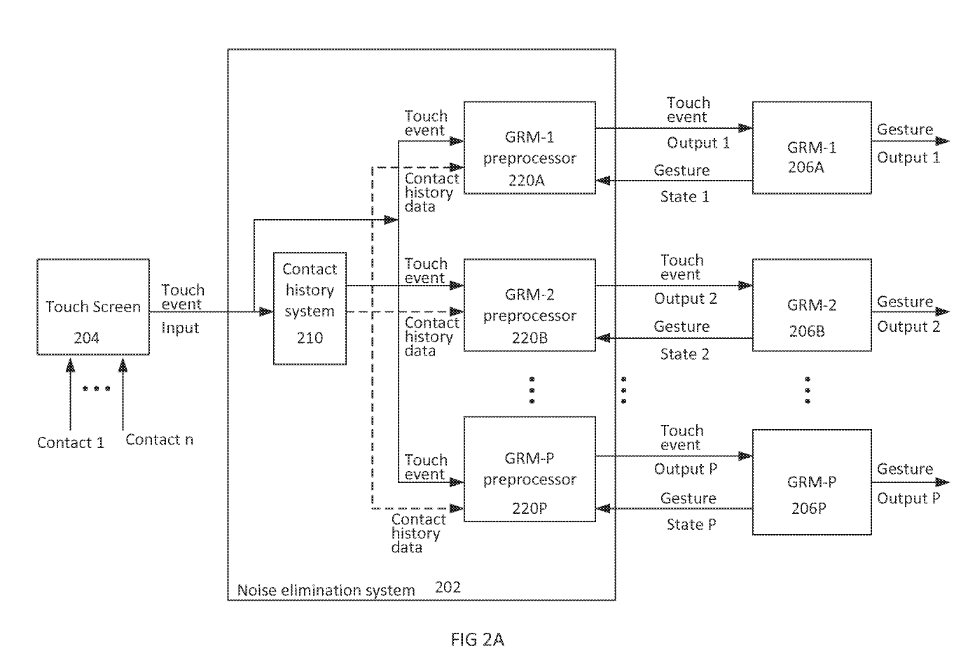

FIG. 2A illustrates an example of a noise elimination system 202 in accordance with one embodiment of the present disclosure. The noise elimination system 202 may be coupled to a touch screen 204 and a plurality of gesture recognition modules (GRMs) 206A, . . . , 206P. Touch screen 204 corresponds to touch screen 106 of FIG. 1. The touch screen 204 is configured to capture (i.e., receive) one or more contact(s), Contact 1, . . . , Contact n, and to generate touch event(s) based on the captured contact(s), as described herein. The touch screen 204 may be configured to capture a maximum number of concurrent contacts, i.e., contacts that have been initiated and have not yet ended. For example, the maximum number of contacts may be n.

The noise elimination system 202 is configured to receive touch event input(s) from touch screen 204 and to provide one or more touch event output(s) (i.e. preprocessed touch event(s)) based, at least in part, on the touch event input(s), to respective GRMs 206A, . . . , 206P. The noise elimination system 202 is further configured to receive a respective gesture state from each GRM 206A, . . . , 206P. Each GRM 206A, . . . , 206P is configured to generate a respective gesture output based at least in part on the preprocessed touch event(s) received from the noise elimination system 202. For ease of description, as used herein, “GRM 206” refers to any one of the gesture recognition module(s) 206A, . . . , or 206P. Reference to a specific GRM will include the letter, for example, GRM 206A refers to a first gesture recognition module, GRM 206B refers to a second gesture recognition module, etc.

The noise elimination system 202 includes at least one contact history system 210 and one or more preprocessor(s) 220A, . . . , 220P. The contact history system 210 is configured to receive touch event input from touch screen 204. The contact history system 210 is further configured to provide contact history data based, at least in part, on the touch event input to the preprocessor(s) 220A, . . . , 220P. In some embodiments, the contact history system 210 may be configured to provide touch event input to the preprocessor(s) 220A, . . . , 220P. In some embodiments, touch event input data may be provided from the touch screen 204 to the preprocessor(s) 220A, . . . , 2201P.

In one embodiment, one contact history system 210 may be utilized by all of the preprocessor(s) 220A, . . . , 220P. In another embodiment, each preprocessor 220A, . . . , 220P may include and/or be coupled to a respective contact history system 210. In this embodiment, contact history system 210 may be repeated for each preprocessor 220A, . . . , 220P. For ease of description, as used herein, “preprocessor 220” refers to any one of the preprocessor(s) 220A, . . . , or 220P and preprocessor 220A refers to a first preprocessor, preprocessor 220B refers to a second preprocessor, etc. Each preprocessor may be associated with a respective GRM. For example, preprocessor 220A is associated with GRM 206A, preprocessor 220B is associated with GRM 206B and so on.

FIG. 2B illustrates an example of a contact history system 210 in accordance with one embodiment of the present disclosure. Contact history system 210 includes a contact history module 212 and one or more contact history vector(s) 214A, . . . , 214N. Each contact history vector 214A, . . . , 214N corresponds to a respective contact. Thus, a maximum number of contact history vectors corresponds to the maximum number of possible contacts, n. As used herein, “contact history vector 214” refers to any one of the contact history vectors 214A, . . . , or 214N. The contact history module 212 is configured to initialize a contact history vector 214 in response to a touch event corresponding to a new contact, to update the contact history vector 214 in response to subsequent touch event(s) (and/or at expiration of a time interval) and to delete the contact history vector 214 in response to a touch event corresponding to an end of the contact. Each contact history vector may include a unique contact identifier (“contact ID”) configured to identify each contact of the up to n contacts.

A contact history vector 214 consistent with the present disclosure may include four elements. The first element includes the x, y coordinates and time stamp of the initial touch event (e.g., TouchStart) of the contact. The second element includes the x, y coordinates and time stamp of the most recent update associated with the contact. The update may be triggered by expiration of a time interval and/or receipt of a subsequent touch event. The third element includes a duration of the contact, i.e., a difference between the time stamp of the most recent update and the time stamp of the initial touch event. The fourth element includes a total distance associated with the contact. The total distance may be determined as a sum of incremental distances between the location associated with the initial touch event, locations associated with intermediate touch events (if any) and the location associated with the most recent update. Thus, contact history vector, H, for a contact with contact ID, Contact ID, may be expressed as:

H(Contact ID)={I₀(x₀,y₀,t₀);I_{q}(x_{q},y_{q},t_{q});(t_{q}−t₀);DT}

where I₀ corresponds to the TouchStart event, x₀ and y₀ are the x, y coordinates of the initial contact location for this contact and t₀ corresponds to the time stamp of the TouchStart event, I_{q} corresponds to the most recent update and x_{q} and y_{q}, are the coordinates of the contact location of the most recent update and t_{q} corresponds to the time stamp of the most recent update and DT (e.g., sum Euclidean distance) may be determined as:

$$DT = {\sum }_{i = 1}^{q} \sqrt{{( {x}_{i} - {x}_{i - 1} )}^{2} + {( {y}_{i} - {y}_{i - 1} )}^{2}}$$

where i corresponds to each touch event associated with the contact beginning with the TouchStart event (i=0) up to the most recent update (i=q).

Thus, contact history 210 may include up to n contact history vectors 214A, . . . , 214N, that include touch event information, as well as duration and distance data configured to allow each preprocessor to select a valid contact from a plurality of contacts. Each preprocessor is further configured to select the valid contact based, at least in part, on a gesture type of a respective gesture recognition module, as described herein.

FIG. 2C illustrates an example of a preprocessor 220 in accordance with various embodiments of the present disclosure. Preprocessor 220 includes a preprocessor module 222 and is configured to store a gesture type 224, a valid contact list 226 and a candidate contact list 228. Gesture type is related to characteristics of a gesture that an associated gesture recognition module is configured to recognize. The preprocessor 220 may be configured with the gesture type during an initialization process of noise elimination system 202, as described herein.

Gesture type and values of metrics (i.e., contact characteristics) associated with the gesture type may be utilized to differentiate a valid contact from a noise contact, to reclassify a candidate contact as a valid contact and/or to select a best valid contact from a plurality of candidate contacts, as described herein. Table 1 includes gesture types and associated metrics.

TABLE 1

Metric

| Gesture Type | Distance | Duration |
|---|---|---|
| Gesture Type 1 | Minimum | Shortest |
| Gesture Type 2 | Minimum | Longest |
| Gesture Type 3 | Maximum | Not applicable |

The metrics (distance and duration) listed in Table 1 correspond to the third and fourth elements in a contact history vector 214. The metrics correspond to preferred contact characteristics of an associated gesture type. For example, the metrics associated with Gesture Type 1 are minimum distance and shortest duration. A tap is an example of a gesture of Gesture Type 1. Thus, a contact that includes little or no movement and is of relatively short duration may correspond to a gesture of Gesture Type 1. The metrics associated with Gesture Type 2 are minimum distance and longest duration. A long tap is an example of a gesture of Gesture Type 2. Thus, a contact that includes little or no movement but does not end until at least a minimum time interval has passed may correspond to a gesture of Gesture Type 2. The metric associated with Gesture Type 3 is maximum distance. A pinch is an example of a Gesture Type 3. Thus, a contact that includes movement may correspond to a gesture of Gesture Type 3.

Each preprocessor may be configured with a gesture type based, at least in part, on characteristics of the gesture associated with a respective gesture recognition module. Relative values of the metrics may be used to select a valid contact from a plurality of candidate contacts. For example, for a gesture of Gesture Type 2, a best valid contact may be selected from a plurality of candidate contacts based, at least in part, on their relative durations. For example, the candidate contact with the longest duration may be selected as the best valid contact. In another example, if the gesture type is Gesture Type 3 and there are two active contacts (e.g., first contact and second contact), if the DT in the contact history vector associated with the first contact is greater than the DT in the contact history vector associated with the second contact, then the first contact may be selected as the valid contact. Thus, relative values of the metrics, determined based on associated contact history vectors, may be used to select a valid contact from a plurality of candidate contacts.

Preprocessor 220 is configured to receive touch event input, contact history data and gesture state (of an associated gesture recognition module) and to provide a touch event output. Valid contact list 226 is configured to store one or more contact IDs corresponding to contacts that may be valid for a gesture corresponding to an associated gesture recognition module. As will be described in more detail below, a noise contact may be initially stored in the valid contact list if the noise contact is the first contact that initiates a gesture recognition process. Valid contact list 226 is configured to store a number, in, of contact IDs. The number in may be based on a number of contacts included in the corresponding gesture. For example, a pinch gesture that utilizes two contacts may correspond to a valid contact list of size two contacts. Candidate contact list 228 is configured to store one or more contact IDs corresponding to contacts that may be noise or may be valid for the gesture corresponding to the associated gesture recognition module. Candidate contact list 228 is configured to store a number, n minus nm, of contact IDs where n is the maximum number of contacts that may be active at a point in time. Preprocessor module 222 is configured to determine a touch event output based at least in part on the touch event input data, contact history data, gesture type 224 and/or gesture state, as described herein.

Thus, noise elimination system 202 is configured to receive touch event input from touch screen 204, to generate a contact history and to provide respective touch event output data to each of the gesture recognition module(s) 206A, . . . , 206P, based at least in part on touch event input, contact history, respective gesture type and respective gesture state. Noise contact(s) may be detected and may be replaced with touch events associated with valid contact(s).

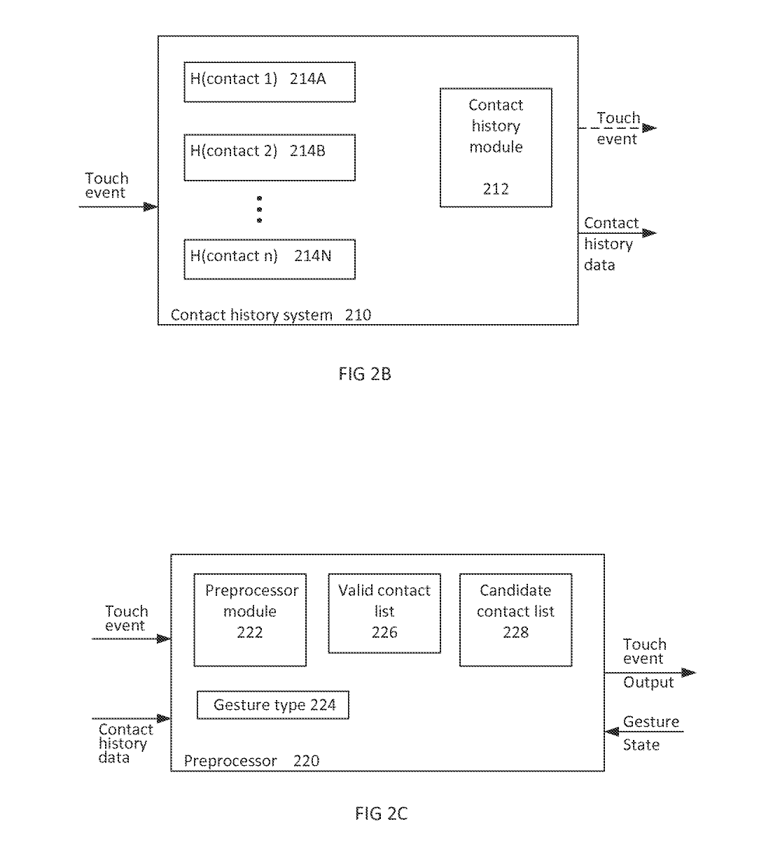

FIG. 3 illustrates a state transition diagram 300 for gesture states associated with a gesture recognition module in accordance with at least one embodiment of the present disclosure. Gesture states correspond to states of a gesture recognition process performed by a gesture recognition module, e.g., GRM 206. “Ongoing” is a characterization of a gesture state utilized by a preprocessor, for example, when determining whether to provide a touch event output to an associated gesture recognition module, and/or when differentiating between a valid contact and a noise contact. The gesture state Started may be characterized as Ongoing. The gesture state Updated is characterized as Ongoing. For gestures that do not have the Updated state, e.g., a tap, the gesture state Started is characterized as Ongoing. For gestures that have the Updated state, e.g., pinch, the gesture state Updated is characterized as Ongoing. Whether gestures that have the Updated state are characterized as Ongoing when they are in the Started state depends on the gesture.

Gesture state None 302 corresponds to a gesture recognition process that has not begun. In the None 302 state, prior gesture recognition processes have ended 310 and/or have been cancelled 312. Depending on the gesture, the gesture state may or may not transition to Started 304 in response to a new contact that causes generation of a TouchStart event. For example, a long tap gesture recognition module may not transition to Started immediately in response to a TouchStart event. Rather, the long tap gesture state may transition to the Started state after a time interval has elapsed. This is configured to allow a tap to happen without a recognition process being triggered in the long tap gesture recognition module.

A gesture state that is Started 304 may transition to Canceled 312 or may transition to Updated 308. For example, for a long tap gesture and associated gesture state of Started, after a time interval has elapsed the gesture state may transition from Started 304 to Updated 308. In another example, the gesture state of a gesture recognition module that is associated with a gesture that includes movement (e.g., pinch gesture), may transition from Started 304 to Updated 308 in response to movement of the contact on the touch screen. In this example, the gesture state may remain Updated 308 as long as the movement continues. The gesture state may transition from Updated 308 to Ended 310 in response to a TouchEnd event (e.g., contact ends). Additionally or alternatively, the gesture state may transition from Updated 308 to Canceled 312, for example, if the gesture corresponds to another gesture recognition module.

For a tap, gesture recognition may function differently. A tap is a relatively short duration contact, e.g., that corresponds to a mouse click. In some embodiments, a tap gesture recognition module may not transition to the started state (i.e., Started 304) until a TouchEnd touch event is received. The tap gesture recognition module may receive a TouchStart event when the contact is initiated and if the tap gesture recognition module receives a TouchEnd prior to an end of a time interval, the tap gesture recognition module may transition the gesture state to Started for another time interval and then transition to TouchEnd. The tap gesture may then be characterized as Ongoing while the gesture state is Started. Thus, depending on the gesture, the associated gesture recognition module may not transition the gesture state to Started immediately in response to a TouchStart event. The transition to Started, if it occurs, may be based, at least in part, on a time interval.

A noise elimination system consistent with the present disclosure is configured to not interrupt a gesture recognition module when its associated gesture state corresponds to Ongoing (i.e., the gesture state is Started or Updated). Ongoing means that an OS and/or app may be responding to the recognized gesture. Halting such a process while ongoing may be detrimental to the user experience and, thus should be avoided.

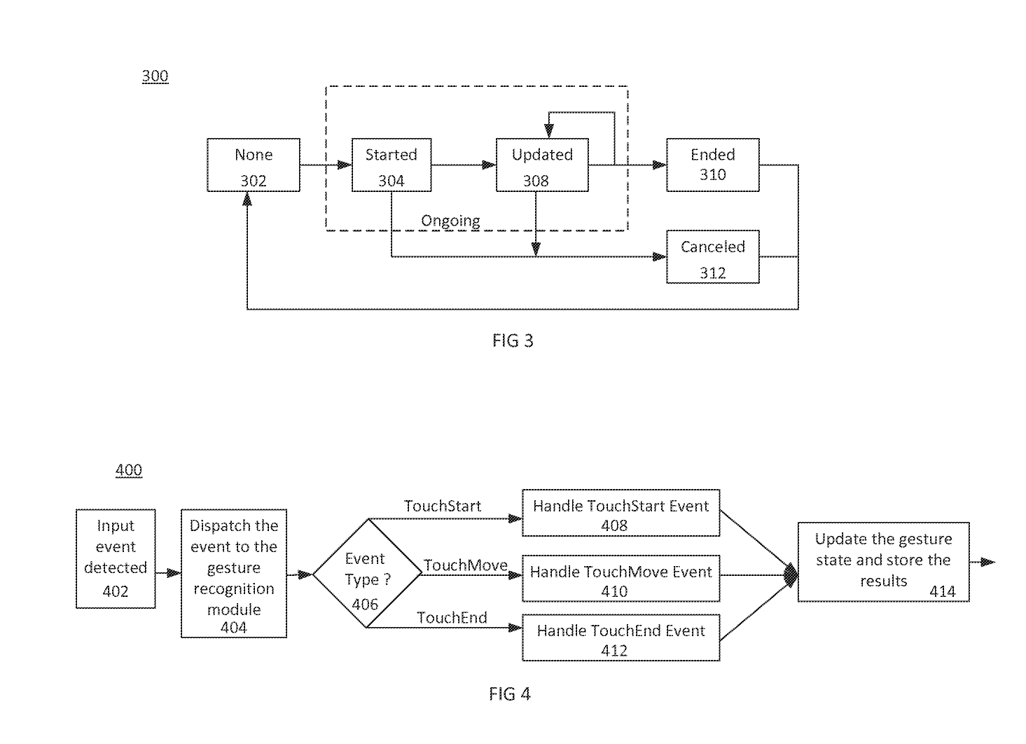

FIG. 4 is a flowchart 400 of example operations for gesture recognition in accordance with at least one embodiment of the present disclosure. Flowchart 400 illustrates a general gesture recognition process. The gesture recognition process illustrated in flowchart 400 may be performed by one or more gesture recognition modules. Program flow may begin when an input event (e.g., a contact resulting in a touch event) is detected 402. The touch event may be dispatched to a gesture recognition module at operation 404. An event type may be determined at operation 406. Event types include TouchStart, TouchMove and TouchEnd. TouchStart corresponds to a new contact on touch screen 204. Touch Move corresponds to a change in position of an existing contact. TouchEnd corresponds to a contact no longer touching the touch screen 204 (e.g., a finger that was touching the touch screen is lifted off the touch screen). If the event type was TouchStart, the TouchStart event may be handled at operation 408. If the event type was TouchMove, the TouchMove event may be handled at operation 410. If the event type was TouchEnd, the TouchEnd event may be handled at operation 412. Operation 414 may include updating the gesture state and storing the results. The operations of flowchart 400 may be performed by a gesture recognition module independent of whether the input event is a touch event from a touch screen or a preprocessed touch event output from a respective preprocessor.

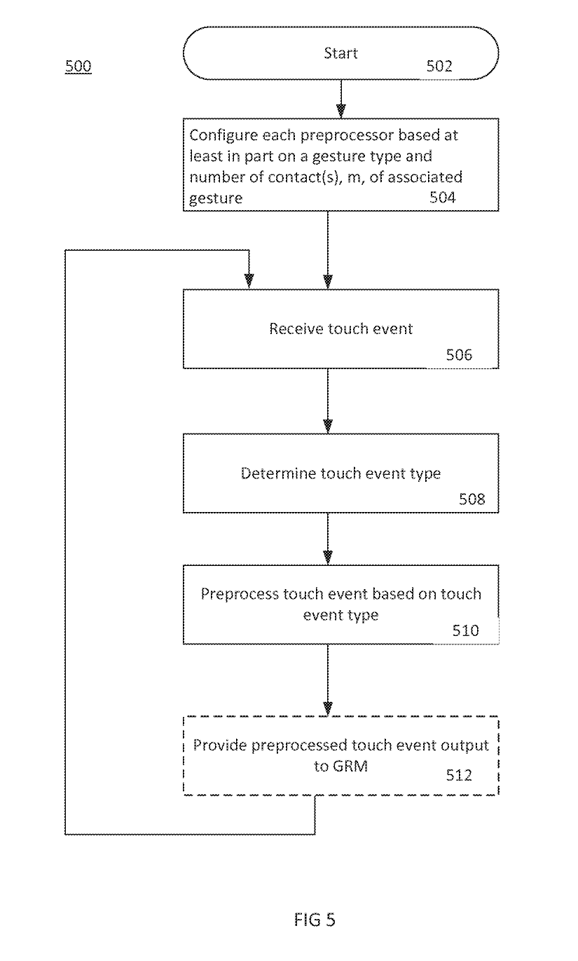

FIG. 5 illustrates a flowchart 500 of exemplary operations consistent with an embodiment of the present disclosure. The operations may be performed, for example, by contact history module 212 and preprocessor 220. In particular, flowchart 500 depicts exemplary operations configured to perform noise elimination in a gesture recognition system. Program flow may begin at Start 502. Operation 504 includes configuring each preprocessor based at least in part on a gesture type and number of contact(s), m, of a gesture of a respective associated gesture recognition module. For example, a preprocessor associated with a tap gesture recognition module may be configured with gesture type corresponding to Gesture Type 1 and the number of contacts equal to one. In another example, a preprocessor associated with a long tap gesture recognition module may be configured with gesture type corresponding to Gesture Type 2 and the number of contacts equal to one. In another example, a preprocessor associated with a pinch gesture recognition module may be configured with gesture type corresponding to Gesture Type 3 and the number of contacts equal to two.

A touch event may be received at operation 506. The touch event may be based on a contact and may include x, y coordinates of the contact and a time stamp associated with the contact. A touch event type may be determined at operation 508. For example, the touch event types may include TouchStart, Touch Move and TouchEnd. Operation 510 includes preprocessing the touch event based on the touch event type. Operation 510 may be performed by a plurality of preprocessors concurrently, with each preprocessor associated with a respective gesture recognition module. Preprocessed touch event output may be provided to a gesture recognition module at operation 512. Whether the preprocessed touch event output corresponds to the received touch event may be based, at least in part, on the received touch event, the gesture type and the gesture state. Program flow may then proceed to operation 506.

Thus, the received touch event may result in a plurality of touch event outputs that may not all be the same. Each respective touch event output may be provided to an associated gesture recognition module. Each gesture recognition module may then perform the operations of flowchart 400 with the touch event output from the preprocessor corresponding to the input event detected at operation 402.

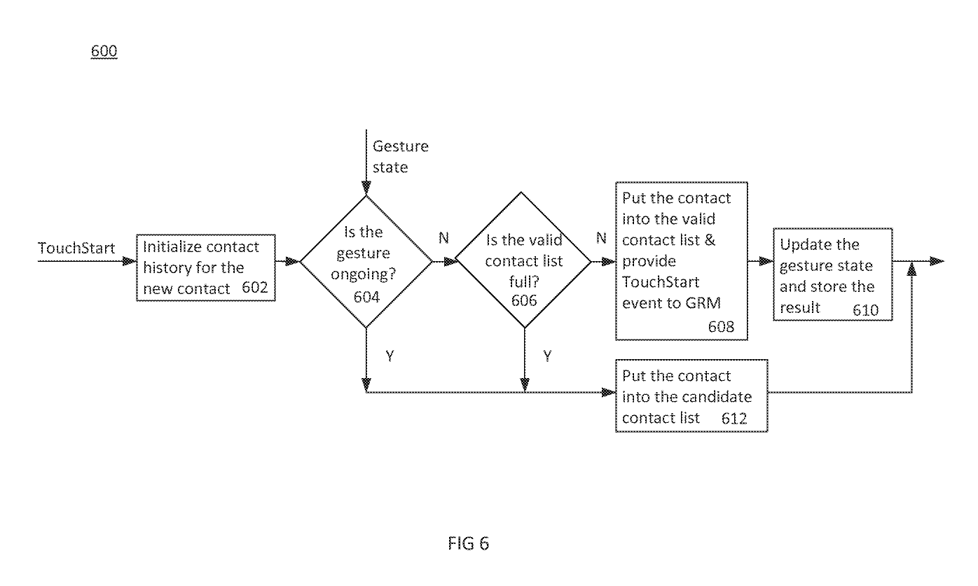

FIG. 6 is a flowchart 600 of example operations for noise elimination in response to a TouchStart event in accordance with at least one embodiment of the present disclosure. The operations of flowchart 600 correspond to operation 510 and operation 512 of flowchart 500 when the event type is TouchStart (i.e., generated when a new contact is initiated). The operations of flowchart 600 are configured to avoid interrupting a gesture that is Ongoing and to avoid interfering with general gesture recognition when noise contacts are not present. Program flow may begin when a TouchStart event is received, for example, from touch screen 204.

Operation 602 includes initializing a contact history for the new contact. For example, operation 602 may include generating the contact history vector for the new contact and storing the contact history vector. Whether the gesture state of an associated gesture recognition module corresponds to Ongoing may be determined at operation 604. For example, if the gesture state received from the gesture recognition module is Started or Updated, then the gesture state corresponds to Ongoing.

Turning now to operations 604 and 606, if the gesture state corresponds to Ongoing or the contact list is full, the contact ID corresponding to the contact may be stored in a candidate contact list at operation 612. If the contact ID is stored in the candidate contact list, the TouchStart event may not be provided to the associated gesture recognition module. The gesture state may then not be updated based on the TouchStart event. If the valid contact list is full, the new candidate contact may be a valid contact or may be a noise contact.

If the gesture state does not correspond to Ongoing, then whether a valid contact list is full may be determined at operation 606. For example, the valid contact list may be full if a number of TouchStart events received prior to beginning the operations of flowchart 600 corresponds to the number of contacts of the associated gesture. Although the valid contact list may be full, fewer than all of the contacts in the valid contact list may actually be valid contacts. In other words, at least one contact may correspond to a noise contact. If the valid contact list is not full, a contact ID corresponding to the contact may be stored in the valid contact list at operation 608. Operation 608 may further include providing the TouchStart event to the associated gesture recognition module. Operation 610 includes updating the gesture state and storing the result. For example, an associated gesture recognition module may be configured to update and store the gesture state based, at least in part, on the received TouchStart event.

Thus, a gesture that is ongoing may not be interrupted in response to a new contact and associated TouchStart event. If the valid contact list is not full, the operations of flowchart 600 are configured to allow updating gesture states, i.e., will not block general gesture recognition. If the valid contact list is full, then a noise contact may be present.

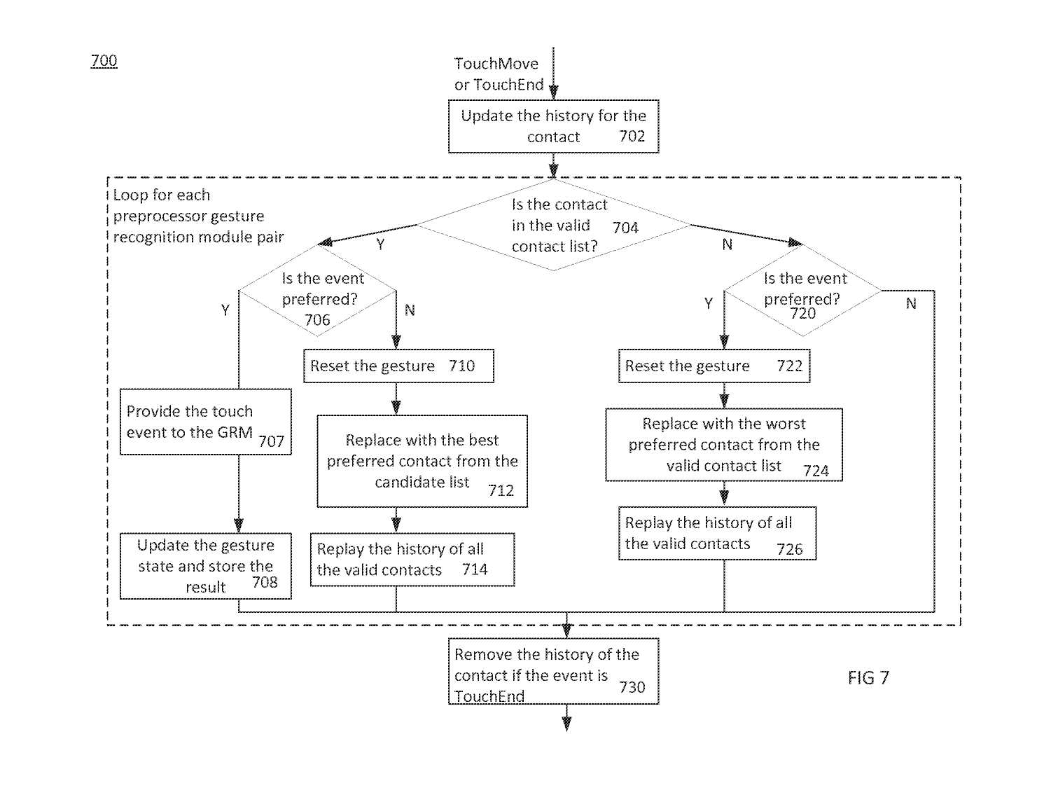

FIG. 7 is a flowchart 700 of example operations for noise elimination in response to a TouchMove or TouchEnd event in accordance with at least one embodiment of the present disclosure. The operations of flowchart 700 correspond to operation 510 and operation 512 of flowchart 500 when the event type is TouchMove or TouchEnd. The operations of flowchart 700 are configured to determine whether a TouchStart event associated with a noise contact has been provided to the gesture recognition module, and, if so, to identify an associated valid contact and to provide the TouchStart event data and most recent touch event data associated with the identified valid contact to the gesture recognition module. The TouchStart event data and most recent touch event data may be retrieved from the associated contact history vector. Subsequent touch events (if any) associated with the valid contact may then be forwarded to the gesture recognition module. FIG. 7 may be better understood when read in combination with Table 1 and Table 2.

TABLE 2

| | Event type and gesture state | | | | | | | |
|---|---|---|---|---|---|---|---|---|
| | Events of Valid Contacts | | | | Events of Candidate Contacts | | | |
| | Ongoing | | Not Ongoing | | Ongoing | | Not Ongoing | |
| | Touch | Touch | Touch | Touch | Touch | Touch | Touch | Touch |
| Gesture Type | Move | End | Move | End | Move | End | Move | End |
| Gesture Type 1 | N | Y | N | N | N | N | N | Y |
| Gesture Type 2 | N | Y | N | N | N | N | N | Y |
| Gesture Type 3 | Y | Y | Y | N | N | N | Y | N |

FIG. 7 in combination with Table 2 represent decision rules based at least in part on gesture type, whether a gesture state corresponds to Ongoing, whether a contact is associated with a valid contact list or a candidate contact list and whether a touch event corresponded to a TouchMove or a TouchEnd. The gesture type metrics included in Table 1 are configured to allow differentiation between gesture types and selection of a best contact from a plurality of contacts of the same gesture type. Table 2 is configured to provide preferences related to valid contacts and noise contacts. A letter N in the table corresponds to a not preferred selection (i.e., a not preferred event for a gesture type) and a letter Y corresponds to a preferred selection (i.e., a preferred event for the gesture type).

The operations of flowchart 700 may begin in response to a TouchMove or TouchEnd touch event generated based on a contact detected (captured) by, e.g., touch screen 204. Operation 702 may include updating the history (i.e., the contact history vector) for the contact. Whether the contact is in the valid contact list may be determined at operation 704. Referring to Table 2, a contact in the valid contact list corresponds to the columns with the heading “Events of Valid Contacts” and a contact not in the valid contact list (i.e., that are in the candidate contact list) corresponds to the columns with the heading “Events of Candidate Contacts”.

If the contact is in the valid contact list, whether the touch event is preferred may be determined at operation 706. Referring to Table 2, preferred touch events are indicated by “Y” and not preferred touch events are indicated by “N”. Operation 706 may thus include determining whether the gesture state of an associated gesture recognition module corresponds to Ongoing or Not Ongoing. Whether the touch event is preferred may then be determined at operation 706 based on gesture type and whether the touch event was a TouchMove or a TouchEnd. For example, referring again to Table 2, if the gesture state corresponds to Ongoing or Not Ongoing and the gesture type is Gesture Type 3 and the touch event type is TouchMove, the touch event is preferred. Referring to Table 1, the metrics associated with Gesture Type 3 correspond to movement, i.e., maximum distance between an initial contact location and a most recent contact location.

If the touch event is preferred, the touch event (i.e., TouchMove or TouchEnd) may be provided to the associated gesture recognition module at operation 707. The gesture state may be updated and the result stored at operation 708. For example, an associated gesture recognition module may update and store the gesture state based, at least in part, on the received touch event. If the touch event corresponds to a TouchEnd touch event, the associated contact history vector may be removed at operation 730. For example, the associated contact history vector may be cleared and the contact ID may be reused for a subsequent new contact.

If the touch event is not preferred, the gesture may be reset at operation 710. For example, the gesture may be reset by providing a reset command to the gesture recognition module causing the gesture state to transition to cancelled. The contact associated with the not preferred event may be replaced (i.e., swapped) with a best preferred contact from the candidate contact list at operation 712. For example, if two contacts, with contact identifiers Contact 1 and Contact 2, are detected and Contact 1 is detected first. Contact 1 may cause a first TouchStart event to be generated. Contact 1 may be stored in the valid contact list and the first TouchStart event may be provided to the long tap gesture recognition module (assuming the gesture state does not correspond to Ongoing). Contact 2 may then cause a second TouchStart event to be generated. In this example, if the preprocessor-gesture recognition module pair is configured to recognize a long tap, then the corresponding gesture type is Gesture Type 2. Since a long tap gesture needs only one contact, Contact 2 may be placed in the candidate contact list of the long tap preprocessor and the second TouchStart event may not be provided to the long tap gesture recognition module. For both Contact 1 and Contact 2, an associated contact history vector may be generated in response to the first TouchStart event and second TouchStart event, respectively.

Continuing with this example, if a TouchMove event is detected associated with Contact 1, the TouchMove event is not preferred for the long tap gesture recognition module since the associated gesture type is Gesture Type 2. Thus, Contact 1 may be a noise contact for the long tap gesture recognizer. If the distance parameter, DT, of the contact history vector associated with Contact 2 is at or near zero, Contact 2 may correspond to the best preferred contact from the candidate list. Contact 2 is preferred since a preferred characteristic for Gesture Type 2 is minimum distance corresponding to little or no movement. Thus, Contact 1 may be replaced (i.e., swapped) with Contact 2 in the valid contact list of the long tap preprocessor.

If the candidate contact list includes a plurality of preferred contacts (i.e., contacts with preferred characteristics according to their gesture type as illustrated in Table 1), then operation 712 may include selecting a best preferred contact based on the preferred characteristics. For example, if the gesture type of the associated gesture recognition module is Gesture Type 2, then preferred characteristics include minimum distance and longest duration. If the candidate contact list includes a first contact and a second contact and if the contact history vectors associated with the first and second contacts have distance values (DT) of zero and non-zero durations then they may both be preferred contacts. If the contact history vector of the first contact includes a duration value greater than the duration value of the second contact, then the first contact may be the best preferred contact since the preferred characteristic for duration is the longest duration. In this manner, a best preferred contact may be selected from a plurality of preferred contacts based on gesture type and the preferred characteristics of each gesture type.

Operation 714 may include replaying the contact history of all of the valid contacts. For example, the TouchStart event data stored in the contact history vector of the valid contact may be provided to the gesture recognition module followed by the most recent touch event data. In this manner, touch event data corresponding to a confirmed valid contact may be provided to the associated gesture recognition module. Program flow may then proceed to operation 730.

Turning again to operation 704, if the contact is not in the valid contact list, whether the touch event is preferred may be determined at operation 720. Whether the touch event is preferred may be determined (following the logic of Table 2 and the columns under the heading “Events of Candidate Contacts”) based on gesture type, whether the gesture state corresponds to Ongoing or Not Ongoing and whether the touch event was a TouchMove or a TouchEnd at operation 720. If the touch event is not preferred, program flow may proceed to operation 730.

If the touch event is preferred, the gesture may be reset at operation 722. The contact associated with the preferred event may be replaced (i.e., swapped) with a worst preferred contact from the valid contact list at operation 724. For example, referring to Table 2, a TouchMove event is preferred for a candidate contact for a gesture recognition module associated with a gesture of Gesture Type 3 and a gesture state corresponding to Not Ongoing. A preferred characteristic for a gesture type of Gesture Type 3 is maximum distance for a contact, i.e., prefers movement. Thus, a worst preferred contact from the valid contact list may correspond to a contact whose distance value, DT, in the associated contact history vector is the smallest relative to the distance value of other contacts in the valid contact list. In this manner, a candidate contact may be moved to the valid contact list and the worst preferred contact from the valid contact list may be moved to the candidate contact list.

Operation 726 may include replaying the contact history of all of the valid contacts. For example, the TouchStart event data stored in the contact history vector of the contact moved to the valid contact list may be provided to the gesture recognition module followed by the most recent touch event data. In this manner, touch event data corresponding to a candidate contact determined to be a valid contact may be provided to the associated gesture recognition module. Program flow may then proceed to operation 730.

While FIGS. 4 through 7 illustrate various operations according to an embodiment, it is to be understood that not all of the operations depicted in FIGS. 4 through 7 are necessary for other embodiments. Indeed, it is fully contemplated herein that in other embodiments of the present disclosure, the operations depicted in FIGS. 4 through 7 and/or other operations described herein may be combined in a manner not specifically shown in any of the drawings, but still fully consistent with the present disclosure. Thus, claims directed to features and/or operations that are not exactly shown in one drawing are deemed within the scope and content of the present disclosure.

As used in any embodiment herein, the term “module” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical locations. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

Thus, the present disclosure provides a method and system for noise elimination in a gesture recognition system. Based on gesture type and contact history, a valid contact may be selected from a plurality of contacts that may include a noise contact. The system includes a preprocessor associated with each gesture recognition module. Initially, each preprocessor may be configured according to the gesture type of the associated gesture recognition module and the number of contacts of the associated gesture. A contact history vector for each contact may be generated in response to a TouchStart event, may be updated while the contact continues and may be deleted when the contact ends (e.g., TouchEnd touch event). The system is configured to avoid interfering with a gesture recognition process that is proceeding without a noise contact and to avoid interrupting an Ongoing gesture recognition process. The system is further configured to select a most preferred contact from a plurality of possibly valid contacts.

According to one aspect there is provided a system. The system may include a touch screen configured to receive a contact and to generate a touch event based on the received contact and processor circuitry configured to execute instructions. The system may further include one or more storage mediums having stored thereon, individually or in combination, instructions that when executed by one or more processors result in the following operations comprising: configuring a preprocessor for a gesture recognition module based, at least in part, on a gesture type, the gesture recognition module related to a gesture; generating a first contact history vector in response to a first touch event, the first touch event based on a first contact with the touch screen; providing the first touch event to the gesture recognition module; and determining whether to provide a second touch event to the gesture recognition module based at least in part on the gesture type.

Another example system includes the forgoing components and further includes configuring the preprocessor based, at least in part, on a number of contacts associated with the gesture.

Another example system includes the forgoing components and further includes receiving a gesture state from the gesture recognition module.

Another example system includes the forgoing components and further includes updating the first contact history vector in response to a third touch event related to the first contact.

Another example system includes the forgoing components and the determining comprises comparing a characteristic of the second touch event to a corresponding characteristic of the third touch event, the gesture type related to the characteristic.

Another example system includes the forgoing components and the gesture type is related to the gesture.

Another example system includes the forgoing components and the gesture type is related to a contact characteristic comprising at least one of a duration and a distance.

Another example system includes the forgoing components and the determining is based, at least in part, on whether a gesture state associated with the first contact corresponds to ongoing.

Another example system includes the forgoing components and the determining is based, at least in part, on the first contact history vector.

Another example system includes the forgoing components and the first contact history vector is configured to store a first location and time associated with the first contact, a most recent location and time associated with the first contact, a duration associated with the first contact and a distance between the most recent location and the first location.

Another example system includes the forgoing components and a first gesture type corresponds to a relatively short duration contact, a second gesture type corresponds to a relatively long duration contact and a third gesture type corresponds to a contact that moves.

According to another aspect there is provided a method. The method may include configuring a preprocessor for a gesture recognition module based, at least in part, on a gesture type, the gesture recognition module related to a gesture; generating a first contact history vector in response to a first touch event, the first touch event based on a first contact with a touch screen; providing the first touch event to the gesture recognition module; and determining whether to provide a second touch event to the gesture recognition module based at least in part on the gesture type.

Another example method includes the forgoing operations and further includes receiving a gesture state from the gesture recognition module.

Another example method includes the forgoing operations and further includes updating the first contact history vector in response to a third touch event related to the first contact.

Another example method includes the forgoing operations and the determining comprises comparing a characteristic of the second touch event to a corresponding characteristic of the third touch event, the gesture type related to the characteristic.

Another example method includes the forgoing operations and the gesture type is related to the gesture.

Another example method includes the forgoing operations and the gesture type is related to a contact characteristic comprising at least one of a duration and a distance.

Another example method includes the forgoing operations and the determining is based, at least in part, on whether a gesture state associated with the first contact corresponds to ongoing.

Another example method includes the forgoing operations and the determining is based, at least in part, on the first contact history vector.

Another example method includes the forgoing operations and the first contact history vector is configured to store a first location and time associated with the first contact, a most recent location and time associated with the first contact, a duration associated with the first contact and a distance between the most recent location and the first location.

Another example method includes the forgoing operations and a first gesture type corresponds to a relatively short duration contact, a second gesture type corresponds to a relatively long duration contact and a third gesture type corresponds to a contact that moves.

According to another aspect there is provided a system. The system may include one or more storage mediums having stored thereon, individually or in combination, instructions that when executed by one or more processors result in the following operations including configuring a preprocessor for a gesture recognition module based, at least in part, on a gesture type, the gesture recognition module related to a gesture; generating a first contact history vector in response to a first touch event, the first touch event based on a first contact with a touch screen; providing the first touch event to the gesture recognition module; and determining whether to provide a second touch event to the gesture recognition module based at least in part on the gesture type.

Another example system includes instructions that when executed by one or more processors result in the forgoing operations and also includes configuring the preprocessor based, at least in part, on a number of contacts associated with the gesture.

Another example system includes instructions that when executed by one or more processors result in the forgoing operations and also includes receiving a gesture state from the gesture recognition module.

Another example system includes instructions that when executed by one or more processors result in the forgoing operations and also includes updating the first contact history vector in response to a third touch event related to the first contact.

Another example system includes instructions that when executed by one or more processors result in the forgoing operations and the determining comprises comparing a characteristic of the second touch event to a corresponding characteristic of the third touch event, the gesture type related to the characteristic.

Another example system includes instructions that when executed by one or more processors result in the forgoing operations and the gesture type is related to the gesture.

Another example system includes instructions that when executed by one or more processors result in the forgoing operations and the gesture type is related to a contact characteristic comprising at least one of a duration and a distance.

Another example system includes instructions that when executed by one or more processors result in the forgoing operations and the determining is based, at least in part, on whether a gesture state associated with the first contact corresponds to ongoing.

Another example system includes instructions that when executed by one or more processors result in the forgoing operations and the determining is based, at least in part, on the first contact history vector.

Another example system includes instructions that when executed by one or more processors result in the forgoing operations and the first contact history vector is configured to store a first location and time associated with the first contact, a most recent location and time associated with the first contact, a duration associated with the first contact and a distance between the most recent location and the first location.

Another example system includes instructions that when executed by one or more processors result in the forgoing operations and a first gesture type corresponds to a relatively short duration contact, a second gesture type corresponds to a relatively long duration contact and a third gesture type corresponds to a contact that moves.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1-33. (canceled)

34. A system, comprising:
a touch screen configured to receive a contact and to generate a touch event based on the received contact;
processor circuitry configured to execute instructions; and
one or more storage mediums having stored thereon, individually or in combination, instructions that when executed by one or more processors result in the following operations comprising:
configuring a preprocessor for a gesture recognition module based, at least in part, on a gesture type, the gesture recognition module related to a gesture;
generating a first contact history vector in response to a first touch event, the first touch event based on a first contact with the touch screen;
providing the first touch event to the gesture recognition module; and
determining whether to provide a second touch event to the gesture recognition module based at least in part on the gesture type.

35. The system of claim 34, wherein the instructions that when executed by one or more processors result in the following additional operations:
configuring the preprocessor based, at least in part, on a number of contacts associated with the gesture.

36. The system of claim 34, wherein the instructions that when executed by one or more processors result in the following additional operations:
receiving a gesture state from the gesture recognition module.

37. The system of claim 34, wherein the instructions that when executed by one or more processors result in the following additional operations:
updating the first contact history vector in response to a third touch event related to the first contact.

38. The system of claim 37, wherein the determining comprises comparing a characteristic of the second touch event to a corresponding characteristic of the third touch event, the gesture type related to the characteristic.

39. The system of claim 34, wherein the gesture type is related to the gesture.

40. The system of claim 34, wherein the gesture type is related to a contact characteristic comprising at least one of a duration and a distance.

41. The system of claim 34, wherein the determining is based, at least in part, on whether a gesture state associated with the first contact corresponds to ongoing.

42. The system of claim 34, wherein the determining is based, at least in part, on the first contact history vector.

43. The system of claim 34, wherein the first contact history vector is configured to store a first location and time associated with the first contact, a most recent location and time associated with the first contact, a duration associated with the first contact and a distance between the most recent location and the first location.

44. The system of claim 34, wherein a first gesture type corresponds to a relatively short duration contact, a second gesture type corresponds to a relatively long duration contact and a third gesture type corresponds to a contact that moves.

45. A method, comprising:
configuring a preprocessor for a gesture recognition module based, at least in part, on a gesture type, the gesture recognition module related to a gesture;
generating a first contact history vector in response to a first touch event, the first touch event based on a first contact with a touch screen;
providing the first touch event to the gesture recognition module; and
determining whether to provide a second touch event to the gesture recognition module based at least in part on the gesture type.

46. The method of claim 45, further comprising:
configuring the preprocessor based, at least in part, on a number of contacts associated with the gesture.

47. The method of claim 45, further comprising:
receiving a gesture state from the gesture recognition module.

48. The method of claim 45 further comprising:
updating the first contact history vector in response to a third touch event related to the first contact.

49. The method claim 48, wherein the determining comprises comparing a characteristic of the second touch event to a corresponding characteristic of the third touch event, the gesture type related to the characteristic.

50. The method of claim 45, wherein the gesture type is related to the gesture.

51. The method of claim 45, wherein the gesture type is related to a contact characteristic comprising at least one of a duration and a distance.

52. The method of claim 45, wherein the determining is based, at least in part, on whether a gesture state associated with the first contact corresponds to ongoing.

53. The method of claim 45, wherein the determining is based, at least in part, on the first contact history vector.

54. The method of claim 45, wherein the first contact history vector is configured to store a first location and time associated with the first contact, a most recent location and time associated with the first contact, a duration associated with the first contact and a distance between the most recent location and the first location.

55. The method of claim 45, wherein a first gesture type corresponds to a relatively short duration contact, a second gesture type corresponds to a relatively long duration contact and a third gesture type corresponds to a contact that moves.

56. A system comprising one or more storage mediums having stored thereon, individually or in combination, instructions that when executed by one or more processors result in the following operations comprising:
configuring a preprocessor for a gesture recognition module based, at least in part, on a gesture type, the gesture recognition module related to a gesture;
generating a first contact history vector in response to a first touch event, the first touch event based on a first contact with a touch screen;
providing the first touch event to the gesture recognition module; and
determining whether to provide a second touch event to the gesture recognition module based at least in part on the gesture type.

57. The system of claim 56, wherein the instructions that when executed by one or more processors result in the following additional operations:
configuring the preprocessor based, at least in part, on a number of contacts associated with the gesture.

58. The system of claim 56, wherein the instructions that when executed by one or more processors result in the following additional operations:
receiving a gesture state from the gesture recognition module.

59. The system of claim 56 further comprising:
updating the first contact history vector in response to a third touch event related to the first contact.

60. The system of claim 59, wherein the determining comprises comparing a characteristic of the second touch event to a corresponding characteristic of the third touch event, the gesture type related to the characteristic.

61. The system of claim 56, wherein the gesture type is related to the gesture.

62. The system of claim 56, wherein the gesture type is related to a contact characteristic comprising at least one of a duration and a distance.

63. The system of claim 56, wherein the determining is based, at least in part, on whether a gesture state associated with the first contact corresponds to ongoing.

64. The system of claim 56, wherein the determining is based, at least in part, on the first contact history vector.

65. The system of claim 56, wherein the first contact history vector is configured to store a first location and time associated with the first contact, a most recent location and time associated with the first contact, a duration associated with the first contact and a distance between the most recent location and the first location.

66. The system of claim 56, wherein a first gesture type corresponds to a relatively short duration contact, a second gesture type corresponds to a relatively long duration contact and a third gesture type corresponds to a contact that moves.
